(19) United States
(12) Patent Application Publication
(10) Pub. No.: US 2026/0368591 A1
(43) Pub. Date: Nov. 19, 2026

(54) A QUANTUM SYSTEM FOR STABILIZING A BOSONIC QUBIT

(71) Applicant: ALICE & BOB, Paris (FR)

(72) Inventors: Diego RUIZ, Paris (FR); Joachim COHEN, Paris (FR); Anil MURANI, Paris (FR)

(21) Appl. No.: 19/486,916

(22) PCT Filed: Mar. 5, 2024
(86) PCT No.: PCT/EP2024/055758

§ 371 Date: Nov. 21, 2025

(30) Foreign Application Priority Data
May 24, 2023 (EP) 23175147.0

(51) Int. Cl. G06N 10/40; G06N 10/20; G06N 10/70

(52) U.S. Cl. CPC G06N 10/40; G06N 10/20; G06N 10/70

(57) ABSTRACT

The present disclosure relates to a quantum system for stabilizing a bosonic qubit comprising: a command circuit including three microwave sources, and a non-linear superconducting quantum circuit including a four-wave mixing non-linear element and a resonant portion, the quantum circuit having a first and a second modes with a first and a second resonant frequencies fₐ, f_{b} respectively. The quantum circuit is arranged to engineer a Hamiltonian H expressed as H/ℏ=g₂(a²+λa†a−α²)b†+h.c., the Hamiltonian H yielding through dissipation of the second mode an effective dissipator D[a²+λa†a−α²] which stabilizes the bosonic qubit. To this end, the first microwave source delivers radiation at a frequency equal to |2fₐ−f_{b}|, the second microwave source delivers radiation at a frequency equal to f_{b}, and the third microwave source delivers radiation at a frequency equal to f_{b} to drive the second mode.

### CROSS-REFERENCE TO RELATED APPLICATIONS

The present application is a national stage application of International Patent Application No. PCT/EP2024/055758, filed Mar. 5, 2024, which claims priority to European Patent Application No. EP23175147.0, filed May 24, 2023, the disclosures of which are hereby incorporated by reference in their entireties.

### TECHNICAL FIELD

The field of the present disclosure relates to stabilizing a bosonic qubit.

### BACKGROUND

Generally speaking, superconducting qubits can be implemented as two-level systems of superconducting electronic circuits. Such qubits can be stored in bosonic modes and thus form a particular class of superconducting qubits known as bosonic qubits.

It is known from the state of the art that it is possible to stabilize cat qubits, i.e. bosonic qubits defined by a quantum manifold spanned by the superpositions of two coherent states, which are quasi-classical states of the bosonic mode. To this end, a specific dissipative stabilization mechanism may be performed and consists in engineering a non-linear conversion between two photons of a first mode—also known as memory mode or cat qubit mode—that hosts the stabilized quantum manifold and one photon of a second mode—also known as buffer mode—that is strongly dissipative.

The cat qubits offer the advantage of having a bit-flip rate that decreases exponentially while the phase-flip rate increases only linearly. As a result, stabilized cat qubits benefit from a high noise bias, which means that the bit-flip probability is much smaller than the phase-flip probability.

Due to their noise structure, cat qubits can be concatenated with a repetition code instead of the usual surface code used for usual superconducting qubits. However, it appears that the noise bias of the cat qubits may not be sufficient to use a simple repetition code for some large-scale algorithms and there is therefore a need to find bosonic qubits with an even higher noise bias.

For this purpose, recent studies have focused on a particular class of cat qubits: the squeezed cat qubits. For instance, Q. Xu et al. (2022) have proposed, in the article “Autonomous quantum error correction and fault-tolerant quantum computation with squeezed cat qubits” (arXiv:2210.13406) to implement an autonomous quantum error correction (AQEC) scheme using squeezed cat code against the dominant error source, excitation loss, in continuous-variable systems. This article announces a noise bias of about 10⁻¹⁵ with only a mean number of four photons to encode the cat-states. As a further example, T. Hillmann et al. (2022) propose and analyze, in the article “Quantum error correction with dissipatively stabilized squeezed cat qubits” (arXiv:2210.13359, Phys. Rev. A 107, 032423), the error correction performance of a dissipatively stabilized squeezed cat qubit.

However, the possibility of stabilizing a squeezed cat qubit faces several obstacles in practice and thus remains purely theoretical as of today. In particular, such a stabilization would require to engineer a multitude of Hamiltonian terms to yield the desired dissipator and thus to use too many pumps to the point of threatening the stability of the system. It can be added that one of these terms, a†²b†, where a is the photon annihilation operator of the first mode and b is the photon annihilation operator of the second mode, requires the injection of a high amount of energy in the system that jeopardizes the coherence of the system.

### SUMMARY

The present disclosure seeks to improve the situation.

To this end, the present disclosure proposes a quantum system for stabilizing a bosonic qubit comprising:
a command circuit including a first microwave source, a second microwave source and a third microwave source each arranged for delivering microwave radiation, and
   a non-linear superconducting quantum circuit including an asymmetrically threaded superconducting quantum interference device and at least one resonant portion to which said asymmetrically threaded superconducting quantum interference device is connected, said asymmetrically threaded superconducting quantum interference device having flux lines through which radiation can be delivered to modulate a common flux and a differential flux, said non-linear superconducting quantum circuit having a first mode with a first resonant frequency and a second mode with a second resonant frequency, said second resonant frequency being different from twice the first resonant frequency, said second mode being dissipative.

The asymmetrically threaded superconducting quantum interference device is arranged such that, when
the first microwave source delivers radiation through said flux lines to modulate the common flux at a frequency equal to the absolute value of the difference between twice the first resonant frequency and the second resonant frequency,
the second microwave source delivers radiation through said flux lines to modulate the common flux at a frequency equal to the second resonant frequency, and
the third microwave source delivers radiation at a frequency equal to the second resonant frequency to the a least one resonant portion to drive the second mode,
the non-linear superconducting quantum circuit engineers a Hamiltonian H expressed as H/ℏ=g₂(a²+λa†a−α²)b†+h.c., where g₂ is proportional to the amplitude of the first microwave source, a is the annihilation operator of the first mode, λ is a complex number which phase and amplitude result from the amplitude of the second microwave source and are each defined relative to the phase and amplitude of the first microwave source respectively, α is a complex number resulting from the third microwave source and defined relative to the first microwave source, b is the annihilation operator of the second mode, and h.c. is the Hermitian conjugate, said Hamiltonian H yielding through dissipation of the second mode an effective dissipator D[a²+λa†a−α²] which stabilizes a two-dimensional manifold hosting the bosonic qubit in the first mode.

According to one or more embodiments, the first microwave source and the second microwave source are configured such that the respective phases of the first microwave source and the second microwave source are substantially equal to each other.

According to one or more embodiments, the second microwave source and the third microwave source are configured such that the respective phases of the second microwave source and the third microwave source are substantially equal to each other.

According to one or more embodiments, the first microwave source, the second microwave source and the third microwave source are configured such that the respective phases of the first microwave source, the second microwave source and the third microwave source are substantially equal to each other.

According to one or more embodiments, the third microwave source is arranged to deliver radiation through the flux lines to modulate the differential flux at a frequency equal to the second resonant frequency to drive the second mode.

According to one or more embodiments, the second microwave source is arranged to deliver radiation whose amplitude causes A to have an amplitude less than or equal to 1.

According to one or more embodiments, the second microwave source is arranged to deliver radiation whose amplitude causes A to have an amplitude substantially equal to 1.

According to one or more embodiments, the respective phases of the first mode and the second mode across the asymmetrically threaded superconducting quantum interference device each have a zero-point fluctuation φₐ, φ_{b}, and the ratio is less than 3.

Furthermore, the present disclosure also proposes a method for stabilizing a bosonic qubit performed by the quantum system described above and comprising the following operations:
delivering, by the first microwave source, radiation through the flux lines to modulate the common flux at a frequency equal to the absolute value of the difference between twice the first resonant frequency and the second resonant frequency,
delivering, by the second microwave source, radiation through the flux lines to modulate the common flux at a frequency equal to the second resonant frequency,
delivering, by the third microwave source, radiation at a frequency equal to the second resonant frequency to the a least one resonant portion to drive the second mode.

The implementation of this method causes the non-linear superconducting quantum circuit to engineer a Hamiltonian H expressed as H/ℏ=g₂(a²+λa†a−α²)b†+h.c., where g₂ is proportional to the amplitude of the first microwave source, a is the annihilation operator of the first mode, A is a complex number which phase and amplitude result from the amplitude of the second microwave source and are each defined relative to the phase and amplitude of the first microwave source respectively, a is a complex number resulting from the third microwave source and defined relative to the first microwave source, b is the annihilation operator of the second mode, and h.c. is the Hermitian conjugate, said Hamiltonian H yielding through dissipation of the second mode an effective dissipator D[a²+λa†a−α²] which stabilizes a two-dimensional manifold hosting the bosonic qubit in the first mode.

### BRIEF DESCRIPTION OF THE DRAWINGS

Other features and advantages of the present disclosure become apparent from the following description provided for indicative and non-limiting purposes, with reference to the accompanying drawings, wherein:

FIG. 1 schematically illustrates a quantum system comprising a non-linear superconducting quantum circuit and a command circuit according to the present disclosure,

FIGS. 2A and 2B illustrate the respective Wigner functions of a standard cat qubit and a bosonic qubit stabilized by the quantum system of FIG. 1,

FIG. 3 illustrates an explicit diagram of the quantum system of FIG. 1,

FIG. 4 illustrates a partial electrical equivalent diagram of a first galvanic example implementation of the quantum system of FIG. 3,

FIG. 5 illustrates a partial electrical equivalent diagram of a second galvanic example implementation of the quantum system of FIG. 3,

FIG. 6 illustrates a partial electrical equivalent diagram of a capacitive example implementation of the quantum system of FIG. 3,

FIG. 7 illustrates the bit-flip rate of the bosonic qubit stabilized by the quantum system of FIG. 1 as a function of the number of photons,

FIG. 8 illustrates the non-adiabatic errors of the quantum system of FIG. 1 resulting from the implementation of a Z gate,

FIG. 9 illustrates a comparison of the non-adiabatic errors between the bosonic qubit stabilized by the quantum system of FIG. 1 and a theoretical squeezed cat qubit, and

FIG. 10 illustrates the bit-flip rate of the bosonic qubit stabilized by the quantum system of FIG. 1 as a function of the ratio of the respective zero-point fluctuations of the superconducting phase of the bosonic qubit mode and the buffer mode.

### DETAILED DESCRIPTION

The drawings and the following description are comprised for the most part of positive and well-defined features. As a result, they are not only useful in understanding the present disclosure, but they can also be used to contribute to its definition, should the need arise.

### Cat Qubits

So far, recent work has been generally concerned with the stabilization of cat qubits. The possibility of realizing such a qubit has been demonstrated by R. Lescanne et al. in “Exponential suppression of bit-flips in a qubit encoded in an oscillator” (Nature Physics, 2020) demonstrated that such cat qubits can be stabilized with a non-linear conversion between two photons of a first mode a—memory mode or cat qubit mode—and one photon of a second mode b—buffer mode.

A cat qubit is defined as a two-dimensional manifold spanned by the so-called cat states |├C_α\hat{ }±) which are superpositions of two coherent states |├α [symbol] and |├−α [symbol] :

|├C_α\hat{ }±)=N\hat{ }±(|├α [symbol] ±|├−α [symbol] )
with:

$${N}^{\pm } = \frac{1}{\sqrt{2 ( 1 \pm {e}^{- 2 \vert a {\vert}^{2}} )}}$$

Stabilized cat qubits are known to benefit from a high noise bias, which means that the bit-flip probability is exponentially smaller than the phase-flip probability. More precisely, an effective error channel (e.g., bit errors or “bit-flips”) is suppressed in an exponential way with the “size”—i.e. the average number of photons n̅=|α|²—of the Schrödinger cat states of the cat qubits. As previously mentioned, this exponential suppression of bit-flip errors is only at the cost of linear increase of phase-flip errors.

According to current knowledge, this suppression should apply to a large class of physical noise processes having a local effect on the phase space of a harmonic oscillator. This includes, but is not limited to, photon loss, thermal excitations, photon dephasing, and various nonlinearities induced by coupling to a Josephson junction.

Recent experiments in the context of quantum superconducting circuits have observed this exponential suppression of bit-flip errors with the average number of photons in the cat states.

### A.1 Stabilization Schemes

The cat qubits can be stabilized or confined by the following exemplary schemes:

a parametric dissipative stabilization, with jump operator L₂=\sqrt{κ₂}(a²−α²), where κ₂ is the two-photon dissipation rate, a is the photon annihilation operator of the memory mode a and α is a complex number defining the cat qubit. This jump operator can be realized by coupling a lossy buffer mode b with dissipation rate κ_{b}, and a four-wave mixing device—typically a Josephson junction or an ATS—to the cat qubit mode a and by engineering the Hamiltonian H/ℏ=g₂(a² [symbol] −α²)b [symbol] +h.c., where b is the photon annihilation operator of the buffer mode b and g₂ is the two-photon coupling rate, by applying to the four-wave mixing device a pump at frequency |2fₐ−f_{b}| and a drive of the buffer mode b at frequency f_{b} provided g₂<κ_{b}.
b) a Kerr Hamiltonian

$$H / ℏ = \frac{K}{2} ( {a}^{† 2} - {a}^{2} ) ( {a}^{2} - \overline{{a}^{2}} ) ,$$

where K is the amplitude of the Kerr Hamiltonian, a is the photon annihilation operator, and | [symbol] α| [symbol] ² is the mean photon number.
c) a detuned Kerr Hamiltonian

$$H / ℏ = \frac{K}{2} ( {a}^{† 2} - {a}^{2} ) ( {a}^{2} - \overline{{a}^{2}} ) - Δ {a}^{†} a ,$$

where K is the amplitude of the Kerr Hamiltonian, a is the photon annihilation operator, α is a complex number defining the cat qubit, and Δ is the detuning factor.
d) a two-photon exchange (TPE) Hamiltonian H/ℏ=g₂(a²−α²)σ₊+h.c., where g₂ is the complex two-photon coupling rate, a is the photon annihilation operator, α is a complex number defining the cat qubit, and σ_{±} are the lowering and raising operators of the two-level system. This Hamiltonian can be engineered in the same way as the parametric dissipative stabilization a).
e) a DC dissipative stabilization, for which the Applicant filed the European patent application EP 23306839.4, in which a cat qubit is stabilized in the spirit of the previous stabilization scheme a), except that the two-photon pump that engineers the non-linear conversion between two photons of the memory mode a and one photon of the buffer mode b is replaced with a DC voltage source which biases a non-linear element formed exclusively of one or more Josephson junctions; the two-photon coupling rate g₂ is therefore not limited by the amplitude of the two-photon pump

$${g}_{2} = \frac{{E}_{J}}{4} {φ}_{a}^{2} {φ}_{b} ,$$

where E_{J} is the Josephson energy of the one or more Josephson junctions, φₐ is the zero-point fluctuation of the phase of the memory mode a, and φ_{b} is the zero-point fluctuation of the phase of the buffer mode b.
f) a resonant dissipative stabilization, with jump operator L₂=κ₂(a²−α²) where κ₂ is the two-photon dissipation rate, a is the photon annihilation operator of the memory mode a and α is a complex number defining the cat qubit. This jump operator can be realized by coupling a lossy buffer mode b with dissipation rate κ_{b}, and a three-wave mixing device to the cat qubit mode a which engineers the Hamiltonian H/ℏ=g₂(a² [symbol] −α²)b [symbol] +h.c., where b is the photon annihilation operator of the buffer mode b provided the mode frequencies verify substantially 2fₐ=f_{b} and g₂<κ_{b} to which a drive of the buffer mode at frequency f_{b} is added.

The following subsection focuses on a particular stabilization scheme: the dissipative squeezing stabilization.

### A.2 The Squeezed Cat Qubit

Cat qubits have the property to allow the realization of quantum gates such as the Z or the CNOT gate while maintaining the noise bias. The characteristics which are used to assess the quality of a quantum gate are its execution time, i.e. the time for the quantum gate to operate, and the associated error probability. For cat qubits, the phase-flip error probability at the optimal time of the gate depends on the ratio κ₁/κ₂, where κ₁ is the single photon loss rate—or error rate since it leads to phase-flip errors—of the cat qubits used to perform the quantum gate, and κ₂ is the two-photon dissipation rate—also called correction or stabilization rate—of these cat qubits. The smaller κ₁/κ₂ is, the better the gate fidelity gets.

It is generally considered that the use of a single repetition code is sufficient to correct the remaining errors as bit-flip errors are sufficiently rare; and, more particularly, a phase-flip error correction code is sufficient to correct the remaining phase-flip. This can be for instance a repetition code defined in the dual base or any other state-of-the-art error correction code.

However, even if the cat qubit has a high noise bias, which is a particularly advantageous feature in the perspective of realizing a quantum error correction and thus designing a reliable quantum computer, it appears that such a noise bias might not be enough for large-scale quantum algorithm with a simple repetition code. In this context, it was recently highlighted that a particular family of cat qubits have an even higher noise bias: the squeezed cat qubits.

The squeezed cat states also have less non-adiabatic errors during the period of time of a quantum gate, such as a Z gate or a CNOT gate. Overall, reducing the non-adiabatic errors allows to reduce the requirement on the ratio κ₁/κ₂.

The squeezed states |├α, ξ [symbol] are defined as:

|α,ξ [symbol] =D(a)S(ξ)|0 [symbol]
with D(α) the displacement operator:

D(α)=e^{αa†-α*a}

And S(ξ) the squeezing operator:

$$S ( ξ ) = \frac{1}{{e}^{2 [ ( ξ * {a}^{2} - ξ {a}^{{†}^{2}} ) ]}}$$

where: ξ is the complex squeezing parameter with norm r=|ξ|.

The squeezed cat states are defined as the coherent superposition of two squeezed states with opposite displacement amplitudes and identical squeezing:

|├C_(α,ξ)\hat{ }± [symbol] =1/(N_(α,ξ)\hat{ }(|├α,ξ [symbol] |├−α,ξ [symbol] )
where:

$${N}_{α , ξ}^{\pm }$$

is a normalization constant.

Note that to have proper squeezed cat states the complex phase of α and ξ must follow:

α=|α|e^{iθ}

ξ=re^{2iθ}

The dissipative squeezing stabilization is based on the following jump operator:

L_{sc}=\sqrt{κ₂}((cosh(r)a+sinh(r)e^{iθ}a†)²−α²)
where: κ₂ is the two-photon dissipation rate, a is the photon annihilation operator, α is a complex number defining the cat qubit, r and θ are the modulus and argument of the complex squeezing parameter ξ=re^{iθ}.

This jump operator can be realized by coupling a lossy buffer mode b with dissipation rate κ_{b}, and a four-wave mixing device—typically a Josephson junction or an ATS—to the cat qubit mode and by engineering the Hamiltonian H/ℏ=g₂L_{sc}b†+h.c., where b is the photon annihilation operator of mode b.

While the dissipation of the cat qubit is of the form D[a²−α²], that of the theoretical squeezed cat qubit is of the following more complicated form D[cosh(r)²a²+sinh(r)²a†²+cosh(r)sinh(r)(2a†a+1)−α²], where ξ and α are assumed to be real numbers without loss of generality. More particularly, the dissipative squeezing stabilization is engineered through the interaction term [cosh(r)² a²+cosh(r) sinh(r) (2a†a+1)+sinh(r)² a†²−α²]b†+h.c.

Consequently, the theoretical implementation of the stabilization of the squeezed cat qubit relies on generating four particular terms:
a²b†+h.c.: this first term corresponds to the non-linear conversion between two photons of a first mode a—the memory—and one photon of a second mode b—the buffer. This term requires a pump at a frequency |2fₐ−f_{b}|, where fₐ is the resonant frequency of the first mode a and f_{b} is the resonant frequency of the second mode b.

a†ab†+h.c.: this second term corresponds to a longitudinal coupling between the first mode a and the second mode b. This term can be obtained with a pump at a frequency f_{b}.

a†²b†+h.c.: this third term requires a pump at a frequency 2fₐ+f_{b}.

α²b†+h.c.: this fourth term requires the drive of the second mode b at a frequency f_{b}.

It must be noted that a so-called “standard cat qubit” is stabilized by only generating the first term a²b†+h.c. and the fourth term a²b†+h.c.

However, a considerable obstacle to the use of squeezed cat qubits is the difficulty of engineering such a dissipative squeezing stabilization. This obstacle is above all due to the multiplicity of terms to be engineered using pumps, which jeopardizes the stability of the system, increases thermal population or reduces coherence times. In addition, it must be noted that the generation of the third term requires a very high frequency 2fₐ+f_{b}, around 15 gigahertz (GHz) assuming that the frequencies fₐ and f_{b} are each typically of 5 gigahertz (GHz). The amount of energy to be injected into the system to reach such a frequency has detrimental effects on the coherence of the system. Moreover, the phase and amplitude of the pump at frequency 2fₐ+f_{b}—for generating the third term a†²b†—must be precisely tuned with respect to the phase and amplitude of the pump at frequency f_{b}—for generating the second term a†ab†—and the drive of the second mode b at frequency f_{b}—for generating the fourth term a²b†.

Therefore, it appears that squeezed cat qubits, although theoretically offering a higher noise bias than cat qubits, are currently not possible to stabilize due to the multiple difficulties of implementing the required dissipation. On the other hand, cat qubits are possible to stabilize but impose extreme conditions of use to achieve a sufficient noise bias and thus run a large-scale quantum algorithm. This fact was the subject of a recent publication by E. Gouzien et al. (2023): “Computing 256-bit Elliptic Curve Logarithm in 9 Hours with 126133 Cat Qubits” (arXiv:2502.06639).

### B. The Moon Cat Qubit

FIG. 1 illustrates a schematic diagram of a quantum system 1 arranged to stabilize a particular type of bosonic qubit: a moon cat qubit.

The quantum system 1 comprises a non-linear superconducting quantum circuit 3 and a command circuit 5.

The non-linear superconducting quantum circuit 3 is arranged to make possible four-wave mixing between a first mode a and a second mode b. In the following, the first mode a hosts a moon cat qubit, while the second mode b is dissipative and is used as a buffer in between the moon cat qubit and the external environment.

In the remainder of the description, the first mode a is referred to as the memory mode, while the second mode b is referred to as the buffer mode.

The memory mode a and the buffer mode b correspond to natural resonant frequencies of the non-linear superconducting quantum circuit 3. Consequently, the memory mode a and the buffer mode b each have a respective resonant frequency. The memory mode a has a resonant frequency

$${f}_{a} = \frac{{ω}_{a}}{2 π}$$

and the buffer mode b has a resonant frequency

$${f}_{b} = \frac{{ω}_{b}}{2 π} ,$$

where ωₐ and ω_{b} are the respective angular frequencies of the memory mode a and the buffer mode b.

By “having” a memory mode and a buffer mode, it should be understood here that the non-linear superconducting quantum circuit 3 comprises components operating in a superconducting regime which host the modes independently of each other or concurrently. In other words, the memory mode a and the buffer mode b may be hosted in different subsets of components of the superconducting circuit or on the same subset of components.

The memory mode a has a high-quality factor Qₐ while the buffer mode b has a low-quality factor Q_{b}. As will be appreciated, the quality factor (Q-factor) can be determined in various ways, for instance by: (a) spectroscopic linewidth measurement, wherein the quality factor is given by

$$Q = \frac{f}{Δ f} ,$$

wherein f is resonant frequency and Δf is the spectroscopic linewidth; or (b) via a time-domain measurement wherein a tone is sent in, and a return signal is measured after a pre-determined time, wherein Q=f*τ with r the characteristic decay time. Of course, the skilled person would be aware of various other methods for determining the quality factor of a particular mode.

The non-linear superconducting quantum circuit 3 is intended to be subject to microwave radiations delivered by the command circuit 5 in order to engineer various non-linear interaction between the memory mode a and the buffer mode b. The frequency of each microwave radiation is tuned to select specific terms within the rotating-wave approximation.

As detailed below, the non-linear superconducting quantum circuit 3 is intended to interact with the command circuit 5 for engineering a particular Hamiltonian H yielding, through dissipation of the buffer mode b, an effective dissipator which stabilizes a two-dimensional manifold hosting the moon cat qubit.

Such a Hamiltonian H can be expressed in the following form:

$$\frac{H}{ℏ} = {g}_{2} ( {a}^{2} + λ {a}^{†} a - {a}^{2} ) {b}^{†} + h . c .$$

Each term of the Hamiltonian H will be explained and detailed below.

The non-linear superconducting quantum circuit 3 comprises a four-wave mixing non-linear element 7 and at least one resonant portion 9.

The four-wave mixing non-linear element 7 is arranged to be parametrically driven by the command circuit 5 to cause the non-linear superconducting quantum circuit 3 to engineer the required Hamiltonian H for stabilizing the moon cat qubit.

More particularly, the four-wave mixing non-linear element 7 is an asymmetrically threaded superconducting quantum interference device—or ATS hereinafter. It is known to the skilled person that an ATS can be used to engineer the 2-to-1 photon conversion, i.e. the first term a²b†+h.c. of the above-mentioned Hamiltonian H, in order to perform a dissipative stabilization, as successfully shown by R. Lescanne et al. (2020).

Contrary to the first implementations of this stabilization scheme proposed by Z. Leghtas et al. in the article “Confining the state of light to a quantum manifold by engineered two-photon loss” (Science, Vol. 347, No. 6224, 2015) and S. Touzard et al. in the article “Coherent Oscillations inside a Quantum Manifold Stabilized by Dissipation” (Physical Review X 8, 023005, 2018) in which the superconducting circuit element used as a four-wave mixer was a transmon with a single Josephson junction, the solution developed by R. Lescanne et al. (2020) exploits the ATS design which has much lower cross-Kerr terms than the transmon and thus allowed to observe the exponential suppression of bit-flips.

The ATS has flux lines through which radiation can be delivered to modulate a common flux and/or a differential flux.

It is known to the skilled person that, when biased at its flux working point (0−π or conversely), the Hamiltonian H_{ATS} of the ATS 7 has the following “sin-sin” form:

$${H}_{ATS} / ℏ = - 2 {E}_{J} sin ( {φ}_{\sum } ( t ) ) sin ( φ ) + \frac{{E}_{L}}{2} {( φ - {φ}_{Δ} ( t ) )}^{2}$$

where: −φ=φₐ(a+a†)+φ_{b}(b+b†) is the total superconducting phase difference across the ATS 7,
φₐ is the zero-point fluctuation of the phase of the memory mode a across the ATS 7,
φ_{b} is the zero-point fluctuation of the phase of the buffer mode b across the ATS 7,
Eⱼ is the Josephson energy of the side junctions,
E_{L} is the inductive energy of the central inductance,
φ_{Σ}(t) corresponds to the common flux modulation of the two loops of the ATS 7,
φ_{Δ}(t) corresponds to the differential flux modulation of the two loops of the ATS 7, and
ℏ is the reduced Planck constant.

The common flux modulation φ_{Σ}(t) can be implemented by delivering microwave radiations through flux lines of the ATS 7 out of phase, while the differential flux modulation φ_{Δ}(t) can be implemented by delivering microwave radiations through flux lines of the ATS 7 in phase.

Parametric pumping of the ATS 7 is typically done by pumping the common flux as pumping the differential flux merely displaces the modes coupled to the ATS 7.

As an example, by pumping the common flux at the frequency fₚ=|2fₐ−f_{b}|, φ_{Σ}(t)=∈_{P} cos(2πfₚt), the non-linear resonant part of the Hamiltonian writes in the rotating frame:

$${H}_{ATS} / ℏ = \frac{{E}_{J} {ϵ}_{p} {φ}_{a}^{2} {φ}_{b}}{2 ( {a}^{2} {b}^{†} + h . c . )}$$

which is typically the 2-to-1 photon exchange Hamiltonian needed to engineer the two-photon stabilization.

To engineer a longitudinal Hamiltonian between the memory mode a and the buffer mode b, the common flux must be pumped at the frequency f_{b}:

φ_{Σ}(t)=∈ₗ cos(2πf_{b}t)

In the rotating frame, the parametric part of the Hamiltonian writes:

$${H}_{ATS} / ℏ = {E}_{J} {ϵ}_{l} {φ}_{b} ( b + {b}^{†} ) ( 1 - {φ}_{a}^{2} {a}^{†} a ) + {E}_{J} {ϵ}_{l} \frac{{φ}_{b}^{3}}{2 ( {b}^{†2} b + {b}^{†} {b}^{2} )}$$

This Hamiltonian can be written as follows to highlight the desired dynamics:

$${H}_{ATS} / ℏ = ℏ {g}_{2} λ {a}^{†} a ( b + {b}^{†} ) - {E}_{J} {ϵ}_{l} {φ}_{b} ( b + {b}^{†} ) + ℏ {g}_{2} λ \frac{{φ}_{b}^{2}}{2 {φ}_{a}^{2}} ( {b}^{†2} b + {b}^{†} {b}^{2} )$$

with

$${g}_{2} λ = \frac{{E}_{J} {ϵ}_{l} {φ}_{b} {φ}_{a}^{2}}{ℏ} .$$

The first term corresponds to the desired longitudinal coupling.

The second term is an effective drive of the buffer mode b at the resonant frequency f_{b}. This term can be used to engineer the term a²b† of the Hamiltonian H. However, since this term needs to be tuned independently of λ, the buffer drive 15—or direct drive—is required.

The third term corresponds to a spurious and possibly detrimental non-linearity. Depending on the noise level, the moon cat qubit stabilization has to deal with, this can lead to a constraint on the ratio

$$\frac{{φ}_{b}}{{φ}_{a}}$$

to ensure this last term is not too detrimental.

The 2-to-1 photon conversion between the memory mode a and the buffer mode b is obtained by parametrically pumping the ATS at the frequency fₚ=|2fₐ−f_{b}|. Advantageously, the pump frequency satisfies fₚ>>g₂ to make this parametric pumping work as well as possible, where g₂ is the two-photon coupling rate.

The particular situation where 2fₐ=f_{b} (f_p=0) is called the resonant case and may be advantageous, as developed in the European patent application EP 21306965.1 filed by the Applicant. However, in such a resonant case, the 2-to-1 photon conversion cannot be activated by parametrically pumping a four-wave mixing non-linear element such as ATS. Instead, a three-wave mixing non-linear element should be used. As we will see later, the longitudinal term of the Hamiltonian H still requires four-wave mixing to be engineered. Hence, the resonant situation, although compatible with the proposed moon cat qubit stabilization requires an extra three-wave mixing non-linear element. In other words, the resonant case requires having both three-wave mixing and four-wave mixing to generate the first term a²b†+h.c. and the second term a†ab†+h.c., respectively. The three-wave mixing can arise by operating the ATS at a different flux point than the 0−π flux point it is usually operated at or by adding another non-linear element as described in the above-mentioned European patent application EP 21306965.1.

The present disclosure proposes to use an ATS to stabilize the moon cat qubit, hence the advantage of verifying |2fₐ−f_{b}|>>g₂ or being outside the resonant regime for the 2-to-1 photon conversion.

The resonant portion 9 is arranged to be coupled or connected to the ATS 7 to provide the non-linear superconducting quantum circuit 3 with the memory mode a and the buffer mode b having respective resonant frequencies fₐ and f_{b}. More particularly, the memory mode a and the buffer mode b “participate” in the ATS 7, which means that a portion or the entirety of the mode magnetic energy is stored in the ATS 7. Such a participation can be quantified by a zero-point fluctuation of the superconducting phase across the ATS, noted φₐ for the memory mode a and φ_{b} for the buffer mode b.

In the schematic diagram of the quantum system 1 illustrated in FIG. 1, the non-linear superconducting quantum system 3 comprises only one resonant portion, i.e. the resonant portion 9. A single resonant portion can be configured to produce both the memory mode a and the buffer mode b. However, the non-linear superconducting quantum system 3 typically comprises two resonant portions to form the memory mode a and the buffer mode b respectively.

The command circuit 5 is arranged to deliver microwave radiations.

The command circuit 5 is arranged to parametrically drive the ATS 7 to implement the non-linear conversion between two photons of the memory mode a and one photon of the buffer mode b, to parametrically drive the ATS 7 to implement the longitudinal coupling between the memory mode a and the buffer mode b, and to drive the buffer mode b.

To this end and as illustrated in FIG. 1, the command circuit 5 comprises a first microwave source 11, a second microwave source 13 and a third microwave source 15.

The first microwave source 11 is arranged to parametrically drive the ATS 7. More particularly, the first microwave source 11 is used to implement a parametric pump delivering radiation at the frequency |2fₐ−f_{b}| to the ATS 7.

In the remainder of the description, the first microwave source 11 is referred to as the two-photon pump.

The second microwave source 13 is also arranged to parametrically drive the ATS 7. More particularly, the second microwave source 13 is used to implement a parametric pump delivering radiation at the frequency f_{b} to the ATS 7.

In the remainder of the description, the second microwave source 13 is referred to as the longitudinal pump.

Finally, the third microwave source 15 is arranged to drive the buffer mode b by delivering a radiation at the frequency f_{b} to the resonant portion 9.

In the remainder of the description, the third microwave source 15 is referred to as the buffer drive.

As explained above, the combined effect of the two-photon pump 11 and the buffer drive 15 allows the non-linear superconducting quantum circuit 3, and more exactly the ATS 7, to perform the non-linear conversion between two photons of the memory mode a and one photon of the buffer mode b as well as the drive of the buffer mode b.

In view of stabilizing a two-dimensional manifold hosting the moon cat qubit, which is the purpose of the quantum system 1, such a combined effect contribute to the generation of the terms a²b†+h.c. and α²b†+h.c. to the Hamiltonian H to be engineered by the non-linear superconducting quantum circuit 3.

Moreover, the parametric pump implemented using the longitudinal pump 13 allows a longitudinal coupling between the memory mode a and the buffer mode b.

The consequence of such a longitudinal coupling is the generation of the term a†ab†+h.c. which also contributes to the Hamiltonian H and thus to the stabilization of the two-dimensional manifold hosting the moon cat qubit.

In response to the radiations delivered by the command circuit 5, the non-linear superconducting quantum circuit 3 engineers a Hamiltonian H expressed as follows:

$$\frac{H}{ℏ} = {g}_{2} ( {a}^{2} + {λa}^{†} a - {α}^{2} ) {b}^{†} + h . c .$$

where: —g₂ is the two-photon coupling rate—or interaction strength—proportional to the amplitude of the two-photon pump 11,
a is the annihilation operator of the memory mode a,
λ is a complex number which phase and amplitude result from the amplitude of the radiation induced by the longitudinal pump 13,
α is a complex number resulting from the buffer drive 15,
b is the annihilation operator of the buffer mode b,
h.c. designates the Hermitian conjugate.

In the expression of the Hamiltonian H, it should be noted that the parameters A and a are both defined relative to the two-photon pump 11. In particular, the phase and the amplitude from which the complex number λ results are each defined relative to the phase and amplitude of the two-photon pump 11 respectively.

In the remainder of the description, the complex number λ is referred to as the moon cat parameter.

It may be noted that such a Hamiltonian H does not comprise the term a†²b†. As explained previously, such a term requires an additional pump which would increase the complexity and threaten the stability of the system. Moreover, this term implies a very high frequency—corresponding to 2fₐ+f_{b}—and pumps a quantity of energy into the system which affects the coherence of the bosonic qubit.

The Hamiltonian H yields through dissipation of the buffer mode b an effective dissipator D[a²+λa†a−α²] which stabilizes the two-dimensional manifold hosting the moon cat qubit.

The relative phase of the microwave sources can be adjusted to obtain the desired number of photons in the memory.

More particularly, advantageously, the phase difference between the two-photon pump 11 and the longitudinal pump 13 is substantially equal to zero. In order words, the two-photon pump 11 and the longitudinal pump 13 are configured such that their respective phases are substantially equal to each other.

Advantageously, the phase difference between the longitudinal pump 13 and the buffer drive 15 is substantially equal to zero. In order words, the longitudinal pump 13 and the buffer drive 15 are configured such that their respective phases are substantially equal to each other.

Preferably, the two-photon pump 11, the longitudinal pump 13 and the buffer drive 15 are configured such that their respective phases are substantially equal to each other.

By “substantially equal”, it should be understood here that, ideally, the respective phases of the concerned microwave source are strictly equal to each other. However, in practice, such equality is difficult to achieve. Typically, the phase of one microwave source deviates by 5% from the phase of the other.

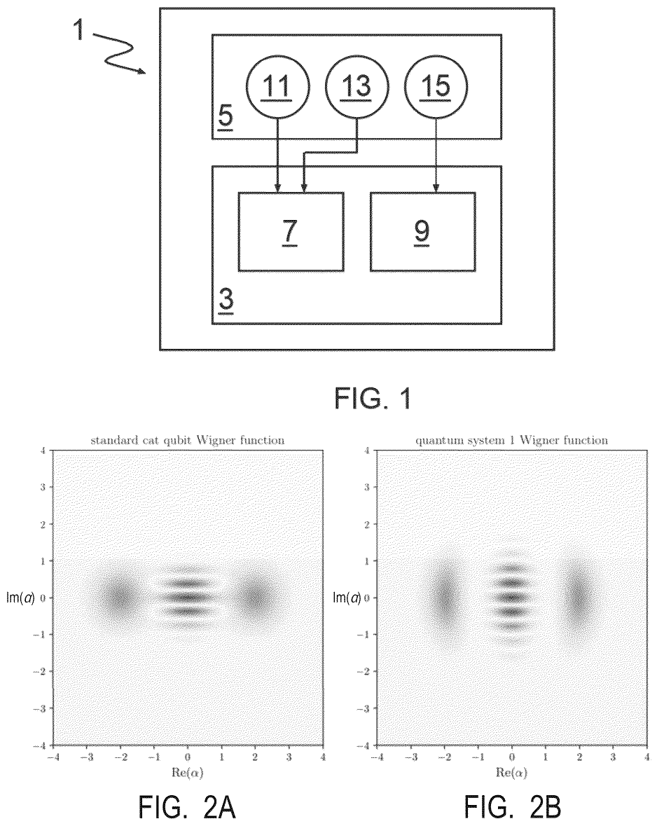

FIGS. 2A and 2B illustrate the respective Wigner functions—or Wigner tomographies—of a standard cat qubit and the moon cat qubit stabilized by the quantum system 1.

It can be noted that the standard cat qubit and the moon cat qubit stabilized by the quantum system 1 have the same number of photons n̅=4, but the latter has a bigger separation in phase-space than the standard cat qubit, meaning the two blobs are more separated. This increased separation at the same number of photons explains the increase in the noise bias.

It can be seen that each of the two blobs has a crescent moon shape. This is why the bosonic qubit stabilized by the quantum system 1 is called “moon cat qubit”.

### B.1 Example Implementations of the Quantum System

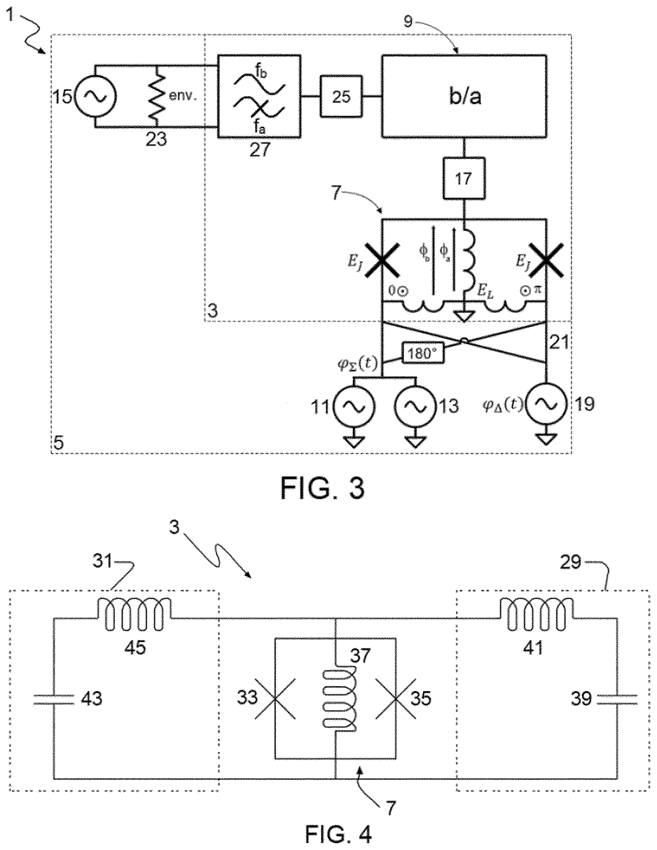

FIG. 3 illustrates more explicitly the schematic diagram of FIG. 1.

The resonant portion 9 takes the form of a linear microwave network connected to the ATS 7 such that, when coupled via a linear coupler 17 to the ATS 7 which acts as an inductive element, the non-linear superconducting quantum circuit 3 has the memory mode a and the buffer mode b at respective resonant frequencies fₐ and f_{b} which participates in the ATS 7.

The two-photon pump 11 and the longitudinal pump 13 are set-up to modulate the common flux in the ATS 7.

In the example illustrated in FIG. 3, the command circuit 5 further comprises a microwave source 19 set-up to modulate the differential flux in the ATS 7.

Such a microwave source 19 can be used to drive the buffer mode b by delivering a radiation at the required frequency f_{b} to the resonant portion 9. In the sense of the present disclosure, the microwave source 19 can thus also be considered as the “third microwave source” or the “buffer drive” instead of the buffer drive 15.

It should be noted that the microwave source 19 can also be used to compensate for a parasitic drive of the buffer mode b caused by the longitudinal pump 13. Although the amplitude and phase of such a compensation drive can be computed analytically, it is fine-tuned experimentally.

In order to clearly distinguish the roles of the sources in the Hamiltonian, a microwave network 21 which applies the correct phase offset is shown in FIG. 3. Alternatively, each microwave source can be simply coupled to a single node of the ATS 7 and their relative phase and amplitude can be set so as to achieve the desired flux modulation. In that case, to modulate the common flux, the microwave sources need to address the circuit out of phase and, to modulate the differential flux, the microwave sources need to address the circuit in phase.

As explained above, the two-photon pump 11 is arranged to deliver microwave radiation to the ATS 7 at a frequency substantially equal to |2fₐ−f_{b}| to cause the non-linear superconducting quantum circuit 3 to perform the 2-to-1 photon conversion between the memory mode a and the buffer mode b, and thus to engineer the term a²b†+h.c. of the Hamiltonian H. To convert this 2-to-1 photon conversion into two-photon dissipation, the buffer mode b is selectively coupled to a load 23 via a linear coupler 25 and a microwave filter 27 configured as a band pass filter with a frequency f_{b}.

Alternatively, the microwave filter 27 may be configured as a band stop filter at a frequency fₐ, and may be placed in between, on the one hand, the external environment and, on the other hand, the memory mode a and the buffer mode b to isolate the memory mode a and thus prevents the memory mode a from suffering additional losses coming from unwanted coupling to the load 23.

Alternatively, it may be configured as a low-pass (respectively high-pass) filter if fₐ>f_{b} (resp f_{b}>fₐ). In other embodiments, the microwave filter 27 can be omitted when coupling between the load 23 and substantially only the buffer mode b can be established. As explained above, the memory mode a has a high-quality factor Qₐ while the buffer mode b has a low-quality factor Q_{b}.

As explained above, the buffer drive 15 is arranged to drive the buffer mode b by delivering microwave radiation to the resonant portion 9 at a frequency substantially equal to the second resonant frequency f_{b} in order to engineer the term a²b†+h.c. of the Hamiltonian H.

Alternatively, the buffer mode b is driven by the microwave source 19 set at frequency f_{b}.

In the above, the load 23 can be seen as part of the command circuit 5 of FIG. 1, while the linear coupler 25 and the microwave filter 27 can be seen as part of the non-linear superconducting quantum circuit 3.

As explained above, the longitudinal pump 13 is arranged to deliver microwave radiation to the ATS 7 at a frequency substantially equal to the second resonant frequency f_{b} to implement a longitudinal coupling between the memory mode a and the buffer mode b in order to engineer the term a†ab†+h.c. of the Hamiltonian H.

### B.1.1 Galvanic Example Implementation

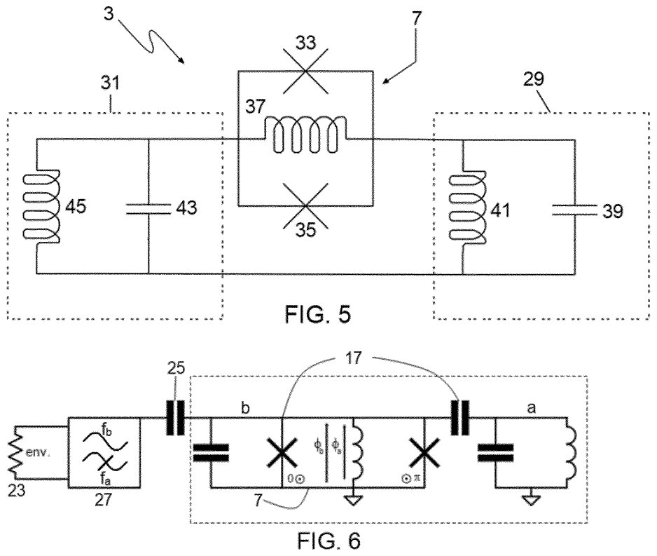

FIGS. 4 and 5 illustrate electrical equivalent diagrams of respective embodiments of the non-linear superconducting quantum circuit 3 which takes the form of a galvanic circuit.

Such electrical equivalent diagrams are partial since they both only represent the ATS 7 and the resonant portion 9, and thus represent neither the linear coupler 25 nor the microwave filter 27. More particularly, the resonant portion 9 includes a first resonant portion 29 and a second resonant portion 31.

The ATS 7 is realized as known in the art, for example in R. Lescanne et al. (2020). The ATS 7 includes a first Josephson junction 33 and a second Josephson junction 35 in parallel, and an inductive element 37 in parallel between them. As a result, the ATS 7 has two connected loops, each loop comprising a Josephson junction 33, 35 in parallel with the shunt inductive element 37. The inductive element 37 can be realized either geometrically or with a chain of junctions. The ATS 7 has both of its loops flux biased in DC and AC. The DC bias sets the working point of the ATS 7. It may be operated near the so-called saddle point, which is a sweet spot in frequency and has small cross-Kerr terms.

Both the first resonant portion 29 and the second resonant portion 31 are galvanically coupled to the ATS 7. The first resonant portion 29 confers the memory mode a having the resonant frequency fₐ to the non-linear superconducting quantum circuit 3, while the second resonant portion 31 confers the buffer mode b having the resonant frequency f_{b} to the non-linear superconducting quantum circuit 3.

By “galvanically coupled”, it should be understood here that there are short electrically conducting portions which connect the first resonant portion 29 and the second resonant portion 31 to the ATS 7, i.e., a short electrically conducting track or any other mean ensuring a physically continuous conducting junction. The expression “short” means that the electrically conducting track has an impedance which is negligeable compared to the impedance of the ATS 7, the first resonant portion 29 and the second resonant portion 31 at the resonant frequencies fₐ and f_{b}. These short electrically conducting portions correspond to the linear coupler 17.

In the embodiment of FIG. 4, the first resonant portion 29 includes a capacitive element 39 and an inductive element 41 which are connected in series. Similarly, the second resonant portion 31 includes a capacitive element 43 and an inductive element 45 which are connected in series.

In the embodiment of FIG. 5, the first resonant portion 29 also includes the capacitive element 39 and the inductive element 41. However, in such an embodiment, the capacitive element 39 and the inductive element 41 are connected in parallel. Similarly, the capacitive element 43 and the inductive element 45 of the second resonant portion 31 are connected in parallel.

In the respective embodiments of FIGS. 4 and 5, the non-linear superconducting quantum circuit 3 includes two resonant portions. However, as previously explained, the non-linear superconducting quantum circuit 3 may comprise only one resonant portion which is arranged to produce both the memory mode a and the buffer mode b.

### B.1.2 Capacitive Example Implementation

FIG. 6 illustrates an electrical equivalent diagram of an embodiment of the non-linear superconducting quantum circuit 3 which takes the form of a capacitive circuit.

Contrary to FIGS. 4 and 5, the external environment is represented. The ATS 7 serves as a central reference point to which the rest of the components are connected. The filtering and external environment of the buffer mode b are also present to this end. The microwave sources have been omitted for simplicity but are arranged in the same way as in FIG. 3 to run the circuit.

In FIG. 6, the linear microwave network is formed by a capacitive element galvanically coupled to the ATS 7 to form the buffer mode b and a parallel LC resonator strongly capacitively coupled to the ATS 7 to form the memory mode a. The couplings to the ATS 7 correspond to the linear coupler 17. Both the memory mode a and buffer mode b are strongly coupled to the ATS 7 as shown by the zero-point fluctuation of the phase of the two modes in central inductance of the ATS 7. The buffer is coupled to the external environment by a capacitive element which corresponds to the linear coupler 25.

### B.2 Characterization of the Moon Cat Qubit

In the present disclosure, the non-linear superconducting quantum circuit 3 engineers a Hamiltonian H expressed as H/ℏ=g₂(a²+λa†a−α²)b†+h.c. The Hamiltonian H yields through dissipation of the buffer mode b the effective dissipator D[a²+λa†a−α²] which stabilizes the two-dimensional manifold hosting the moon cat qubit.

If the respective phases of the second microwave 13 and the buffer drive 15 (or alternatively 19) are properly tuned, λ and α² possess the same complex phase, and can thus be taken real without loss of generality. Thus, unless otherwise stated, λ and α are assumed to be real numbers.

In analogy with the even and odd cat states |├C_α\hat{ }± [symbol] , the even, respectively odd, moon cat state of the moon cat qubit hosted by the two-dimensional manifold stabilized using the quantum system 1 is a superposition of moon cat states that contain only even, respectively odd, Fock states. The expansion on Fock basis of the even moon cat state

$${〚 \vert {C}_{α}^{+} 〉 〛}_{MCS}$$

and the odd moon cat state

$${〚 \vert {C}_{α}^{-} 〉 〛}_{MCS}$$

is the following (MCS stands for “moon cat state”):

$${〚 \vert {C}_{α}^{+} 〉 〛}_{MCS} = {N}^{+} {\sum }_{m \geq 0} 〚 {μ}_{2 m} \vert 2 m 〉$$

with:

$${μ}_{2 m} = \frac{1}{\sqrt{2 m !}} {\prod }_{q = 0}^{m - 1} ( {a}^{2} - 2 λ q ) ∀ m > 0$$

μ₀=1
and:

$${〚 \vert {C}_{α}^{-} 〉 〛}_{MCS} = {N}^{-} {\sum }_{m \geq 0} 〚 {μ}_{2 m + 1} \vert 2 m + 1 〉 〛$$

with:

$${μ}_{2 m + 1} = \frac{1}{\sqrt{( 2 m + 1 ) !}} {\prod }_{q = 0}^{m - 1} ( {a}^{2} - λ ( 2 q + 1 ) ) ∀ m > 0$$

μ₁=1
where: N⁺ and N⁻ are normalization constants.

The figure of merit of the implementation of the quantum system 1 is the relative amplitude of the term a²b†+h.c. and a†ab†+h.c. In this regard, if a comparison between the moon cat qubits of the present disclosure and the theoretical squeezed cat qubits could be established, λ could be expressed as a function of the complex squeezing parameter ξ=re^{iθ} as follows:

λ=2 tanh(r)

Like for the squeezed cat, the bit-flip probability is exponentially decreased by increasing the value of λ—or equivalently r for the squeezed cat.

### B.3 Performances of the Moon Cat Qubit

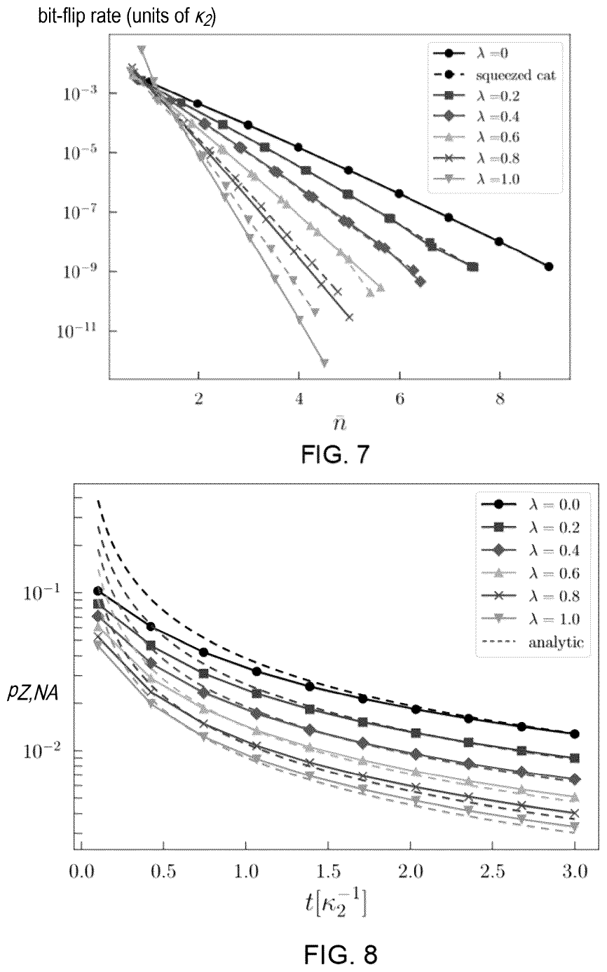

FIG. 7 illustrates the bit-flip probability as a function of the number of photons and for different values of the moon cat parameter λ. More particularly, for each value of the moon cat parameter λ, there is a solid line which corresponds to the bit-flip rate of the moon cat qubit stabilized by quantum system 1 and a dotted line which corresponds to the bit-flip rate of the comparable squeezed cat qubit. By “comparable”, it should be understood here that, for a given value of the moon cat parameter λ, we consider the squeezed cat qubit obtained with a parameter r=tanh⁻¹(λ/2) in accordance with the preceding formula.

It appears that, for λ=1 and at a number of photons n̅=4, the bit-flip of the moon cat qubit stabilized by the quantum system 1 is improved by six orders of magnitude compared to the bit-flip of the standard cat qubit at the same number of photons.

FIG. 7 shows that, in the case in which the value of the moon cat parameter λ is less than or equal to 1, the moon cat qubit (solid lines) involves the same improvement in terms of bit-flip as the squeezed cat qubit (dotted lines) or even slightly better.

As previously explained, the phase and amplitude of the moon cat parameter λ both result from the amplitude of the radiation induced by the longitudinal pump 13. Advantageously, the amplitude of the radiation induced by the longitudinal pump 13 is tuned so that the moon cat parameter λ is equal to 1. Beyond this value, the moon cat qubit stabilized by quantum system 1 is affected by a saturation phenomenon and its performance is therefore less good than the theoretical performance of the squeezed cat qubit.

The quantum system 1 also shows less non-adiabatic errors during the implementation of the gate. The description below focuses on the Z gate, but it can be directly generalized to the CNOT gate.

During the implementation of a Z gate with a known cat qubit, i.e. a cat qubit stabilized by generating only the term a²b†+h.c. and the term a²b†+h.c., two kinds of error may occur:
the single photon loss error given by n̅κ₁T, where n̅ is the number of photons in the cat states, κ₁ is the single photon loss and T is the duration of the gate,
the non-adiabatic errors due to the fact that the gate is performed in a finite time

$$\frac{{π}^{2}}{16 {\overline{n}}^{2} {κ}_{2} T} ,$$

where κ₂ is the two-photon exchange rate. The non-adiabatic errors prevent to perform the gate as fast as possible in order to avoid the increasing of the single photon loss.

A compromise has to be found between the single photon loss error and the non-adiabatic errors since the former is proportional to the duration of the gate, whereas the latter is proportional to the inverse of the duration.

The quantum system 1 has less non-adiabatic errors than the known cat qubit. The non-adiabatic errors of the quantum system 1 during a Z gate are given by the following formula:

$$\frac{{π}^{2} \frac{1}{{( 1 - {λ}^{2} / 4 )}^{2}}}{16 {( \overline{n} - \frac{{λ}^{2}}{4 ( 1 - \frac{{λ}^{2}}{4} )} )}^{2} {( \frac{1 + \frac{λ}{2}}{1 - \frac{{λ}_{2}}{2}} )}^{2} {κ}_{2} T}$$

FIG. 8 shows simulations of the non-adiabatic errors of the quantum system 1 during a Z gate as a function of the gate time in unit of

$$\frac{1}{{κ}_{2}}$$

and for a fixed number of photons n̅=4. It can be seen that, when the value of the moon cat parameter λ increases, the non-adiabatic errors are reduced. The solid lines show numerical simulations and the dotted lines the formula above-mentioned.

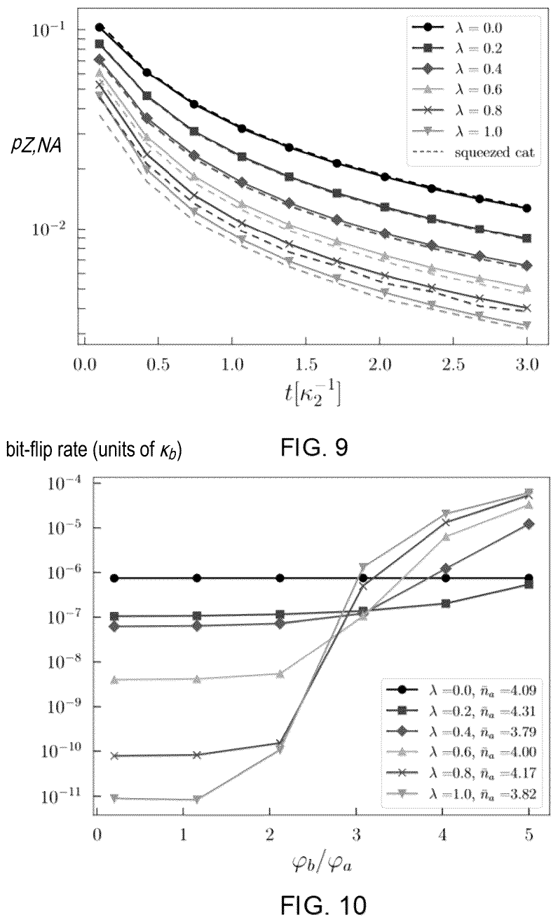

FIG. 9 illustrates a comparison of the non-adiabatic errors between the moon cat qubit stabilized by the quantum system 1 (solid lines) and the squeezed cat qubit (dotted lines), and shows that the quantum system 1 performs as well as the squeezed cat qubit.

The way the moon cat qubit is stabilized by the quantum system 1 implies that a spurious term of the form b†b(b†+b) is activated by the longitudinal pump 13, where b is the photon annihilation operator of the buffer mode b, that is dissipative. However, this spurious term is not detrimental to the quantum system 1 if its amplitude is small enough. As mentioned above, its amplitude is proportional to

$$ℏ {g}_{2} λ \frac{{φ}_{b}^{2}}{2 {φ}_{a}^{2}} ,$$

where φₐ and φ_{b} are the zero-point fluctuations of the superconducting phase of the memory mode a and the buffer mode b respectively across the ATS 7, and where g₂λ is the amplitude of the sought-for longitudinal coupling.

Finally, FIG. 10 illustrates the bit-flip rate of the moon cat qubit stabilized by the quantum system 1 as a function of the ratio

$$\frac{{φ}_{b}}{{φ}_{a}}$$

with a photon number approximately given by n̅ₐ=4 in the memory mode a. The different approximate values of n̅ₐ in this figure are due to the fact that, in practice, this value is difficult to fix. This figure clearly shows that, as long as

$$\frac{{φ}_{b}}{{φ}_{a}} < 3 ,$$

the moon cat qubit stabilized by the quantum system 1 preserves an advantage over the standard cat qubit. More particularly, the curve corresponding to the standard cat qubit is that obtained for λ=0.

It should be noted that this threshold value for

$$\frac{{φ}_{b}}{{φ}_{a}}$$

depends in a non-trivial manner on the noise parameters of the quantum system 1 and on the ratio

$$\frac{{g}_{2}}{{κ}_{b}} .$$

In FIG. 10, the curves correspond to the following experimentally relevant parameters:

a ratio

$$\frac{{g}_{2}}{{κ}_{b}} = 0.1 ,$$

the photon loss rate of the buffer mode

$$b \frac{{κ}_{b}}{2 π} = 60$$

megahertz (MHz),
the photon loss rate of the memory mode a

$$\frac{{κ}_{a}}{2 π} = 0 \text{.05}$$

megahertz (MHz),
a dephasing rate of the memory mode a

$$\frac{{κ}_{ϕ}}{2 π} = 0.01$$

megahertz (MHz), and
a thermal population of the memory mode a nₜₕ=1%.

1. A quantum system for stabilizing a bosonic qubit comprising:
a command circuit including a first microwave source, a second microwave source (13) and a third microwave source each arranged for delivering microwave radiation; and
a non-linear superconducting quantum circuit including a four-wave mixing non-linear element and at least one resonant portion to which said four-wave mixing non-linear element is connected, said non-linear superconducting quantum circuit having a first mode (a) with a first resonant frequency and a second mode (b) with a second resonant frequency, said second resonant frequency being different from twice the first resonant frequency, said second mode (b) being dissipative, wherein:
the four-wave mixing non-linear element being arranged such that, when:
the first microwave source delivers radiation at a frequency equal to the absolute value of the difference between twice the first resonant frequency and the second resonant frequency to parametrically drive the four-wave mixing non-linear element;
the second microwave source delivers radiation at a frequency equal to the second resonant frequency to parametrically drive the four-wave mixing non-linear element; and
the third microwave source delivers radiation at a frequency equal to the second resonant frequency to the at least one resonant portion to drive the second mode (b); and
the non-linear superconducting quantum circuit engineers a Hamiltonian H expressed as H/ℏ=g₂(a²+λa†a−α²)b†+h.c., where g₂ is proportional to the amplitude of the first microwave source, a is the annihilation operator of the first mode (a), λ is a complex number which phase and amplitude result from the amplitude of the second microwave source and are each defined relative to the phase and amplitude of the first microwave source respectively, a is a complex number resulting from the third microwave source and defined relative to the first microwave source, b is the annihilation operator of the second mode (b), and h.c. is the Hermitian conjugate, said Hamiltonian H yielding through dissipation of the second mode (b) an effective dissipator D[a²+λa†a−α²] which stabilizes a two-dimensional manifold hosting the bosonic qubit in the first mode (a).

2. The quantum system of claim 1, wherein the first microwave source and the second microwave source are configured such that the respective phases of the first microwave source and the second microwave source are substantially equal to each other.

3. The quantum system of claim 1, wherein the second microwave source and the third microwave source are configured such that the respective phases of the second microwave source and the third microwave source are substantially equal to each other.

4. The quantum system of one of claim 1, wherein the first microwave source, the second microwave source and the third microwave source are configured such that the respective phases of the first microwave source, the second microwave source and the third microwave source are substantially equal to each other.

5. The quantum system of one of claim 1, wherein the four-wave mixing non-linear element is an asymmetrically threaded superconducting quantum interference device, wherein the quantum system further comprises flux lines through which radiation can be delivered to modulate at least a common flux through the asymmetrically threaded superconducting quantum interference device, and wherein the third microwave source is arranged to deliver radiation through the flux lines to modulate the differential flux at a frequency equal to the second resonant frequency to drive the second mode (b).

6. The quantum system of claim 1, wherein the second microwave source is arranged to deliver radiation whose amplitude causes λ to have an amplitude less than or equal to 1.

7. The quantum system of claim 6, wherein the second microwave source is arranged to deliver radiation whose amplitude causes λ to have an amplitude substantially equal to 1.

8. The quantum system of claim 1, wherein the four-wave mixing non-linear element is an asymmetrically threaded superconducting quantum interference device and the respective phases of the first mode (a) and the second mode (b) across the asymmetrically threaded superconducting quantum interference device each have a zero-point fluctuation φₐ, φ_{b}, and wherein a ratio
$$\frac{{φ}_{b}}{{φ}_{a}}$$
is less than 3.

9. A method for stabilizing a bosonic qubit performed by a quantum system and comprising the following operations:
delivering, by a first microwave source, radiation through flux lines to modulate a common flux at a frequency equal to an absolute value of a difference between twice a first resonant frequency and a second resonant frequency,
delivering, by a second microwave source, radiation through the flux lines to modulate the common flux at a frequency equal to the second resonant frequency,
delivering, by a third microwave source, radiation at a frequency equal to the second resonant frequency to the at least one resonant portion to drive a second mode (b),
the implementation of said method causing a non-linear superconducting quantum circuit to engineer a Hamiltonian H expressed as H/ℏ=g₂(a²+λa†a−α²)b†+h.c., where g₂ is proportional to an amplitude of the first microwave source, a is an annihilation operator of a first mode (a), A is a complex number which phase and amplitude result from an amplitude of the second microwave source and are each defined relative to a phase and amplitude of the first microwave source respectively, α is a complex number resulting from the third microwave source and defined relative to the first microwave source, b is an annihilation operator of the second mode (b), and h.c. is the Hermitian conjugate, said Hamiltonian H yielding through dissipation of the second mode (b) an effective dissipator D[a²+λa†a−α²] which stabilizes a two-dimensional manifold hosting the bosonic qubit in the first mode (a).

10. The quantum system of claim 1, wherein the four-wave mixing non-linear element is an asymmetrically threaded superconducting quantum interference device.

11. The quantum system of claim 10, further comprising flux lines through which radiation can be delivered to modulate at least a common flux through the asymmetrically threaded superconducting quantum interference device, and wherein the first microwave source and the second microwave source are both arranged to deliver radiation through said flux lines to modulate said common flux at frequencies respectively equal to the absolute value of the difference between twice the first resonant frequency and the second resonant frequency and the second resonant frequency.

12. The quantum system of claim 10, wherein further comprising flux lines through which radiation can be delivered to modulate at least a differential flux through the asymmetrically threaded superconducting quantum interference device, and wherein the third microwave source is arranged to deliver radiation through said flux lines to modulate said differential flux at a frequency equal to the second resonant frequency to drive the second mode (b).
